(19) United States
(12) Patent Application Publication
(10) Pub. No.: US 2011/0213646 A1
(43) Pub. Date: Sep. 1, 2011

(54) WEB-BASED REVIEW SYSTEM TO ENABLE SALES REFERRALS AND COMMISSIONS IN DISTRIBUTED ENVIRONMENTS

(76) Inventor: Junaid Ali, Lakewood, OH (US)

(21) Appl. No.: 13/035,687

(22) Filed: Feb. 25, 2011

Related U.S. Application Data
(60) Provisional application No. 61/308,501, filed on Feb. 26, 2010.

(51) Int. Cl. G06Q 30/00; G06F 17/30

(52) U.S. Cl. 705/14.16; 707/705; 707/E17.044

(57) ABSTRACT

A network based review management system and method for managing a plurality of enrolled websites and a plurality of review content items includes a network, a first database of enrolled websites connected to the network, and a second database of review content items connected to the network. Each of the enrolled websites of the first database is associated with one or more review content items of the second database. When one of the enrolled websites is accessed over the network, the one or more review content items from the second database are delivered over the network to the accessed one of the enrolled websites for viewing thereof and/or one or more review content items is added over the network to the second database through the accessed one of the enrolled websites.

### CROSS REFERENCE

This application claims the benefit of U.S. Provisional Patent Application Ser. No. 61/308,501 filed Feb. 6, 2010, which is expressly incorporated herein by reference.

### BACKGROUND

The present invention relates generally to methods and systems to disseminate and contribute review-enabled content with extensive tracking and rewarding capabilities. In one exemplary embodiment, a central application is employed that implements multi-faceted reviews functionality and manages advertiser and website partners.

Online community networks have gained tremendous popularity recently. Many of these networks allow third-party applications to provide software services to users of these communities by installing or attaching the application on user profiles of the users. Some of the applications utilize user relationships amongst each other to create more interesting services such as allowing users to share information about their friends and things they like in an online community and third-party applications.

Applications also gain popularity by word of mouth and sharing activities within the online communities. For example, one user in a community system may share an application with another user. This sharing act may cause the second user to install or attach the application to his or her profile too for interaction with the application.

However, applications are currently limited in determining the causes and sources for users to install applications and therefore they do not have the ability to provide credit to the entities behind the causes and sources. Current systems do not easily identify the content that causes key user activities, thus quality content is not promoted or rewarded such that entities are motivated to enable them for users to benefit. For example, systems cannot determine if a review or article with high ratings shared amongst users causes enrollments of new users. Furthermore, rewarding the various entities in a multitude of sources is limited in existing systems.

### SUMMARY

According to one aspect a system is provided for managing tracking of referral sources whether the sources are individuals or businesses. In an exemplary embodiment, the tracking can occur in off line and online modes and can be recorded in a database. When users share or message other users, the tracking of such actions can also be recorded in a database. Another function of this system can be to allow multiple websites and businesses to participate and share their user base with one another. In the same or another aspect, a multi-user, multi-website and content delivery system is described that enables extensive and configurable referrals and rewards.

### BRIEF DESCRIPTION OF THE DRAWINGS

FIG. 1 is an exemplary schematic diagram showing major entities and relationships with a review management system (RMS), and also showing how content can be generally accessed in the RMS.

FIG. 2 is an exemplary block diagram showing generally how advertisers can distribute their ads in the RMS and some ways users can attain rewards, points and statuses.

FIG. 3 is an information flow diagram showing exemplary tracking capabilities of the RMS.

FIG. 4 is a block diagram showing an exemplary method for website and advertiser partner-matching.

FIG. 5 is an information flow diagram showing exemplary many-to-many possibilities of websites to advertisers.

FIG. 6 is an information flow diagram showing exemplary reward results generation based on inputs and reward rules sets.

FIG. 7 is an information flow diagram showing exemplary user and website statuses generation based on various inputs and status rules sets.

FIG. 8 is an information flow diagram showing exemplary content delivery being affected by a user's social network data and website relevancy profiles in the RMS.

FIG. 9 is an information flow diagram showing exemplary collaborative reward rules sets processing.

FIG. 10 is an information flow diagram showing exemplary collaborative status rules sets processing.

FIG. 11 is a block diagram showing an exemplary method for generating rewards based on quality of content.

### DETAILED DESCRIPTION

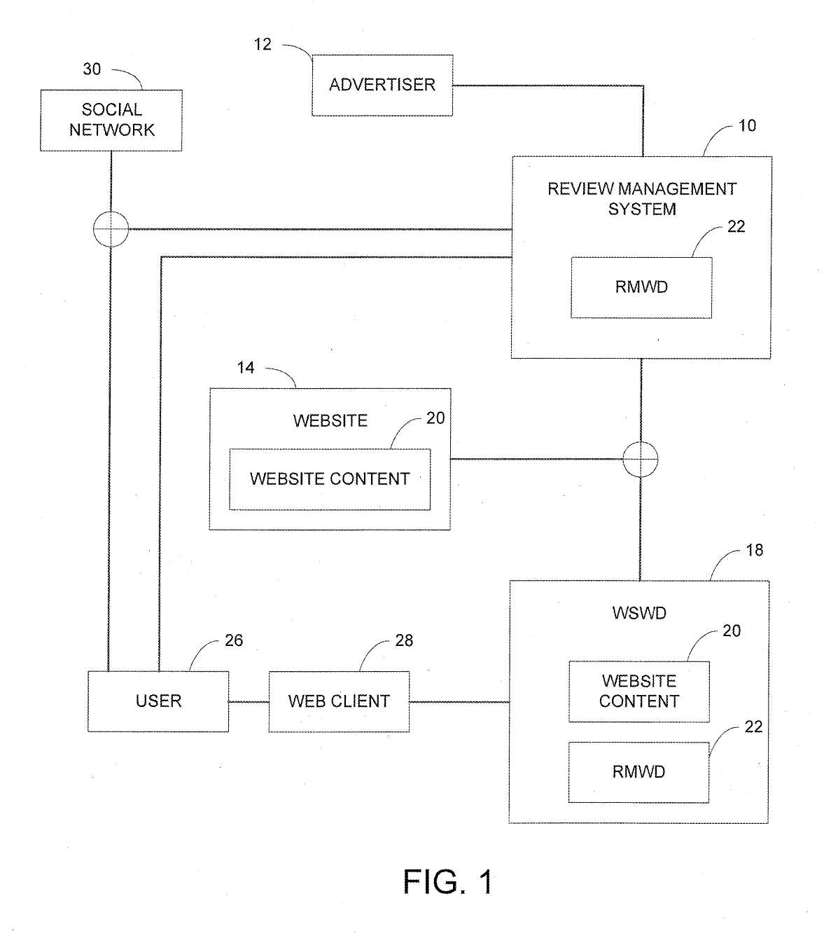

Referring now to the drawings, wherein the showings are for purposes of illustrating one or more exemplary embodiments and not for purposes of limiting same, FIG. 1 illustrates a web-based system including a review management system (RMS) 10 in accordance with an exemplary embodiment that allows an ad (not shown) of an advertiser 12 and a website 14 to be coupled for display to one or more users 26. As shown, a website web document (WSWD) 18 can include website content 20 and a review management web document (RMWD) 22 (wherein the ad may appear). In the illustrated embodiment, users 26 can employ a web client 28 to access the website web document 18 and display the information contained therein (e.g., the website content 20 from a website 14 and the RMWD 22 from the RMS 10). The review management system 10 can be a reviews and ratings system that can be accessed by the users 26 directly or indirectly (via the website 14, for example) in a network such as the Internet. For clarity, the illustrated system is described with reference to a single advertiser 12 and a single website 14; however, it should be appreciated that advertiser 12 can be representative of a plurality of advertisers and website 14 can be representative of a plurality of websites. Accordingly, the review management system 10 can provide a plurality of useful functionalities for one or more users, one or more websites, one or more advertisers, etc.

In the system of FIG. 1, one of the users 26 can access the RMS 10 via a direct access method (DAM) and/or an indirect access method (IAM) to generally utilize functionality of the RMS 10 as further described in U.S. application Ser. No. 11/674,662 (hereinafter, the “the '662 application”), which was filed on Feb. 13, 2007 and is entitled “Web-Based Application or System For Managing and Coordination Review-Enabled Content,” and which is expressly incorporated herein by reference. In one approach, user 26 accesses the RMS 10 directly as represented schematically by the direct connection between the user 26 and the RMS 10. In another approach, user 26 accesses the RMS 10 via the web client 28 to indirectly access the RMS 10. Again, it is to be appreciated that there can be many users accessing the RMS 10 (i.e., element 26 can represent a plurality of users) and utilizing its functionality, both directly and indirectly.

In one example, user 26 can also enroll in the RMS 10 as a member user. Such user enrollment can occur via the DAM or the IAM. A member user can have additional functionality available to him or her than would a user who is not a member user. For example, in one embodiment, only a member user can rate externally generated content in the RMS 10. In another example, the user 26 must be a member user to generate user generated content. Also there can be user settings that are only activated when a user logs in to the system 10 as a member user. An example of a user setting is when a user logs in and accesses item reviews that the user saved in a user account previously. Another user setting could be when a user accesses content prioritized and/or filtered based on user preferences that the user specifies in the user setting.

FIG. 1 also includes a social network 30 that provides user social information to the RMS 10. As shown schematically, the user can access the social network 30 directly and the RMS 10 can communicate with the social network 30. While only a single social network 30 is illustrated and referenced herein, it is to be appreciated that element 30 can be representative of multiple social networks and is not limited to a single social network.

Any such limitations on user or other functionality are optional implementations in the RMS 10. Any reference to a user in this documentation refers to a member user unless otherwise indicated. However, since a member user has additional functionality available compared to a non-member user, references to a member user may not apply to a user unless the user is logged into the system as a member user.

FIG. 1 also shows that users 26 can access a website 14 via a WSWD 18 and can enroll in the RMS 10 as a member user via the RMWD 22. A user may also enroll as a member user by accessing RMS 10 directly. In the case a user enrolls directly at RMS 10, the originating website of that user can be set as the RMS and the RMS can be treated as a website for calculating rewards and other website functionalities.

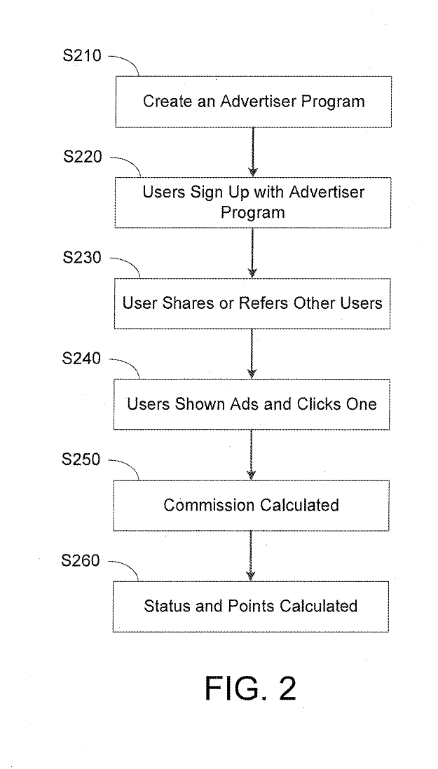

FIG. 2 illustrates an exemplary method in which advertisers can participate in a review management system. The method of FIG. 2 will be described in association with the system illustrated in FIG. 1, though it is to be appreciated that the method could be used with other systems and/or review management systems and is not limited to the system and/or RMS 10 shown in FIG. 1 or described in association with FIG. 1. In the method, an Advertiser 12 can create an account with the RMS 10 (S210), When an account is created in S210, the advertiser 12 can be provided with initial program settings. One example advertiser program setting is a tracking code prefix such as “1AA” and also an initial tracking code that utilizes the prefix such as “1AA-1234”. Another setting can be targeting the content target by specifying one or more product categories and also utilizing factors of content such as user type. The content targeting can be used in partner matching with websites. Partner matching in the RMS 10 can occur as described in the '662 application referenced above.

Once an advertiser program is created in S210, users 26 can sign up with the advertiser program (S220). When new users enroll in the Advertiser program in S220, the RMS 10 can generate a tracking code specific to each user based on the prefix. For example, a first user of the users 26, e.g., User 1, may get a new tracking code such as “1AA-9302” and a second, different user of the users 26, e.g., User 2, may get a tracking code such as “1AA-3892”. The tracking code generated by the RMS 10 for each user may be random but still would utilize the prefix of the Advertiser program. Users 26 may also utilize the login settings of a connected social network system (e.g., system 30) that provides user login and relationship services to the RMS 10. A user 26 may also access a website (e.g., website 14) via the IAM and participate in the Advertiser program provided the website is matched with the advertiser 12 in the partner-matching process of the RMS 10 as described in the '662 application reference above.

The advertiser 12 or a participating website 14 can communicate the initial tracking code to users 26 in marketing materials or embed it in a link to the RMS 10 so that users 26 can enroll in the program when they access the RMS 10. The advertiser 12 may also choose to function as a website (e.g., website 14) as well and allow the users to access the RMS 10 and their programs via their website by users accessing the RMS 10 via the IAM method.

Once an advertiser program is created in S210 and users sign up with the advertiser program in S220, the users 26 can then share content or generally refer other members to enroll in the advertiser program (S230). The users 26 can then be shown ads and one or more of the users 26 can click on an ad (S240). When this occurs, a commission can be calculated (S250) for the responsible user. More particularly, by utilizing the auto-generated tracking codes, the RMS 10 can identify in detail the referral chain of users starting with the users who utilized the initial code down to any level of users. Thus if a particular user generated revenue by clicking on an ad in S240, the referral chain users and website that the user started from may be recognized and get rewarded in S250. It will be appreciated by those skilled in the art that many referral tracking methods can be used. Finally, the RMS 10 can calculate points and statuses for entities due to the advertisement click or changes in number of referrals and other events (S260).

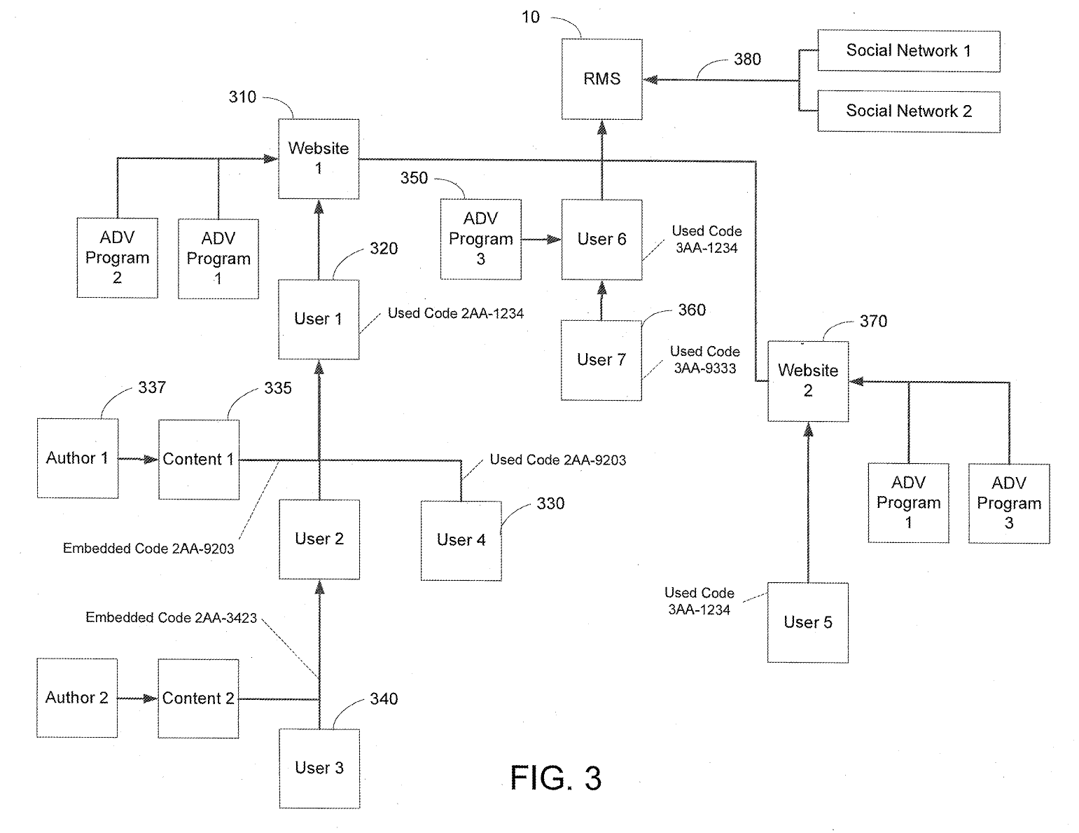

Another advertiser program setting is a URL in which users 26 can access the advertiser program. For example, with reference to FIG. 3, users can access an advertiser program URL and enroll directly into an advertiser program 350. Users do not necessarily have to utilize the initial tracking code as the URL can serve to identify which program the user wants to access. If a user accesses the RMS 10 without an advertiser program URL, the user would be able to use the advertiser program initial tracking code to enroll in the advertiser program 350. A user may utilize the initial tracking code of the advertiser program to enroll in the advertiser program when accessing the RMS 10 to choose which advertising programs they would like to participate in. If a website had two advertiser programs available, as shown in website 310 for example, the user would enter the initial tracking code or a user tracking code to indicate which advertiser program they are participating in within the RMS portion of the website web document (e.g., RMWD 22 of WSWD 18).

With continued reference to FIG. 3, an exemplary manual method of enrollment will now be described. Users (referrers) may refer other users (referrals) to enroll via manual enrollment. The referral user is given the user tracking code of the referrer user. For example, the user tracking code “2AA-9302” of User 1 320 is given to User 4 330. User 4 then accesses the RMS 10 via the website 310 and enters “2AA-9302” as the code into the RMS 10. The RMS 10 now can associate the User 1 320 as the referrer of the User 4 330. The RMS 10 can also generate a unique user tracking code for the User 4 330 so that User 4 can also refer other users.

Users can share review-enabled content or the reviews themselves to enroll other users and become their referrer. For example, since the RMS 10 can utilize a social network login and user relationship data 380, the RMS 10 can allow users to send content to users' friends. This can be done via message stream of the users or other social networking features. An example linked message that introduces Content 1 335, shows on the social network screen of a user's friend is “User 1 shared a review with you (User 2), click here to access it”. When User 2 or anyone that sees the message in the social network accesses the link of the message, the RMS 10 is initiated with the sign-in of the User that clicked it. Since User 1 320 shared the review, anyone accessing that link becomes User 1's referrer. The link would contain an embedded referral code (e.g., 2AA-9203) of User 1 that would communicate to the RMS 10 which user and which advertiser program to enroll the new referred user into. This example shows that by sharing users can enroll other users into RMS advertiser programs.

Tracking of user referrals and related data can be extensive in the RMS 10. For example in FIG. 3, the referrer user 320 has an Originating Website (OWS) from which the referrer user enrolled. There is also the Access Website (AWS) of which the referred user 330 used. The AWS and OWS can be different websites or the same website. The author and rating of the content 335 that caused the referred user to enroll can also be tracked. There is also an OWS and an AWS of the author 337 of the content (i.e., Content 1) that was shared. Many scenarios are enabled by the RMS 10, with some such non-limiting examples illustrated in FIG. 3. All the users and websites and content that contributed to enrolling a user are part of the referral chain of that user. For example, FIG. 3 illustrated that User 3 340 enrolled due to User 2 sharing Content 2 (by Author 2) via Website 1 and therefore Website 1, User 2, Author 2 and Content 2 are all part of the referral chain of User 3. Since User 2 has a referral chain of User 1, Author 1 and Content 1 335, all become part of the referral chain of User 3 as well. User 1, Content 1 and Author 1 are said to be a different level in the referral chain of User 3. Authors are users that created the content in RMS.

In some cases where referred users extend their account with the RMS to become websites or advertisers, the referrer user can gain additional statuses and rewards for the general activity of the referred website or advertiser in the RMS.

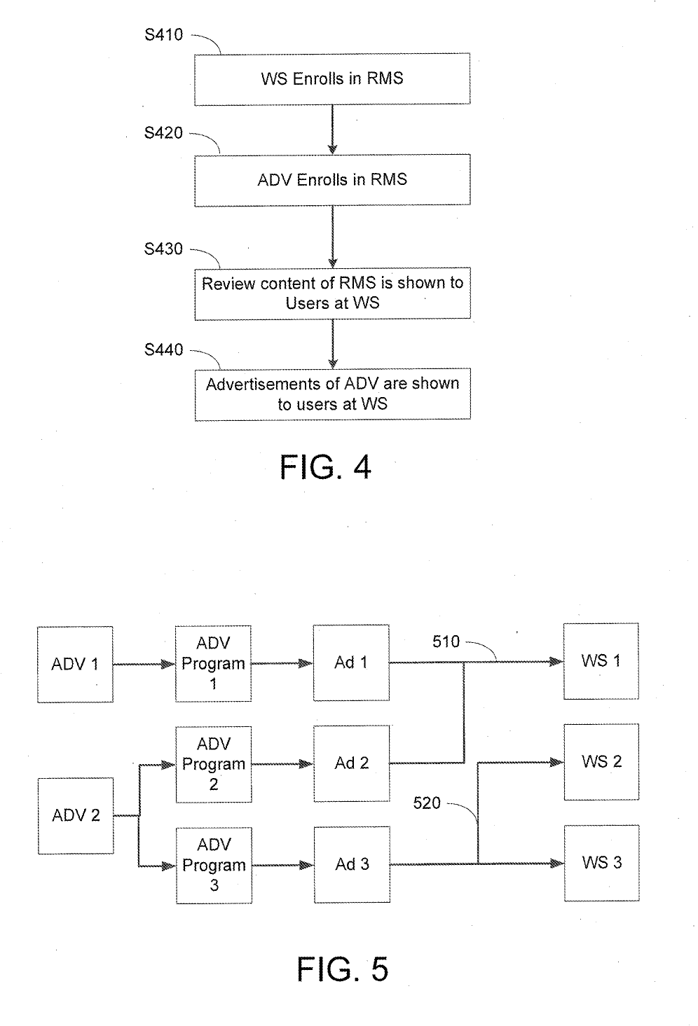

With reference now to FIG. 4, an exemplary method for website and advertiser partnership matching will now be described. In the method of FIG. 4, a website (WS) enrolls in the RMS (e.g., RMS 10) and implements the RMS on one or more of websites (S410). The WS sets up a partner-matching profile and a relevancy profile as described in the '662 application referenced above. Content that is distributed in a review management web document that is coupled with a website web document is subject to the website relevancy profile. Next, an Advertiser enrolls in the RMS (S420). This can include setting up the advertiser's partner-matching profile as described in the '662 application.

When users access the RMS via a WS, they are shown relevant review-enabled content and are automatically enrolled into one or more advertiser programs (S430). The advertiser programs available at a website are subject to partner matching between advertisers and websites in RMS. Users each get a personalized referral code so they can share with other users and gain referrals. The review-enabled content shown is subject to the relevancy profile of the website (for example, as described in the '662 application). Users may interact with and share the relevant review content with other users to gain referrals. The user can optionally decline an advertiser program and choose other advertiser programs that the partner-matching functionality allows for the WS.

Users are also shown ads of the advertiser programs they are enrolled in (S440). The advertiser programs or ads that are displayed to a user at a website may also be subject to the website relevancy profile. Once enrolled in an advertiser program, the user may also get the ads of the program via email or other means as they choose. Users may also customize how they would like the ads to be delivered to them at the website or by directly accessing RMS or via email and other methods.

With reference to FIG. 5, exemplary many-to-may partnership matching will now be described. In particular, there is a many-to-many relationship between ads of an advertiser program and websites. FIG. 5 shows that Ad1 and Ad2 can be delivered as indicated at 510 to a user at Website 1. Ad1 can be of a different Advertiser program and a different Advertiser than represented by Ad2. Ad3 of FIG. 5 is going to two different users via two different websites WS1 and WS2 as indicated at 520. In the illustrated example, the users accessing the Ads are accessing via the websites in the indirect method of the RMS.

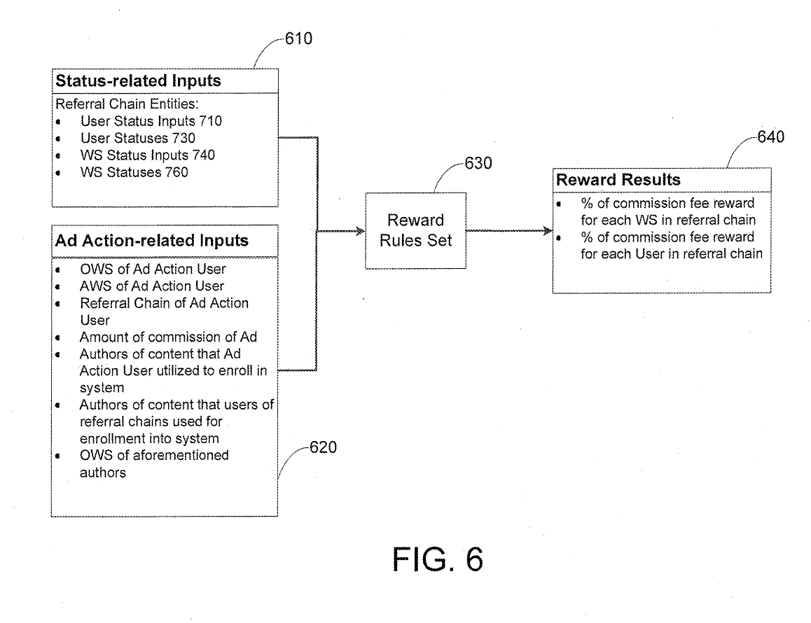

With reference to FIG. 6, exemplary reward functionality will now be described. When a User clicks an Ad, this is an Ad Action. There are rewards generated for Users and websites that are part of the referral chain of the User that performed the Ad Action. The available rewards may be a percentage of the commission fee charged by the RMS to the Advertiser. Other commission fee arrangements could be made between the RMS and the Advertisers. Those rewards would also be calculated by the RMS system. FIG. 6 shows exemplary status-related inputs 610 being combined with Ad Action inputs 620 into a reward rules set 630. The logic and rules set in the reward rules set will be applied to the inputs to generate reward results 640.

Rewards portion 640 of the commission fee can be divided amongst many in the RMS. The receiving entities of the reward could be:
Any user in the referral chain of the User that clicked the Ad, such users referred to as reward referral chain users of an ad click;
Any author user of content that caused any reward referral chain user of the User that clicked that ad; and/or
the OWS or AWS of any aforementioned user and the user that clicked the ad.

Multiple users from multiple websites may choose an ad collectively by selecting it and when a predetermined number of users have selected it, then a Group Ad Action occurs. When a Group Ad Action occurs, rewards for referral chain users and websites of each Group Ad Action user are also generated similar to the rewards generated for a single-user Ad Action.

The RMS can allow administrators, users, advertisers or websites to create reward rules sets that instruct the system on how to distribute the commission fee as rewards to entities.

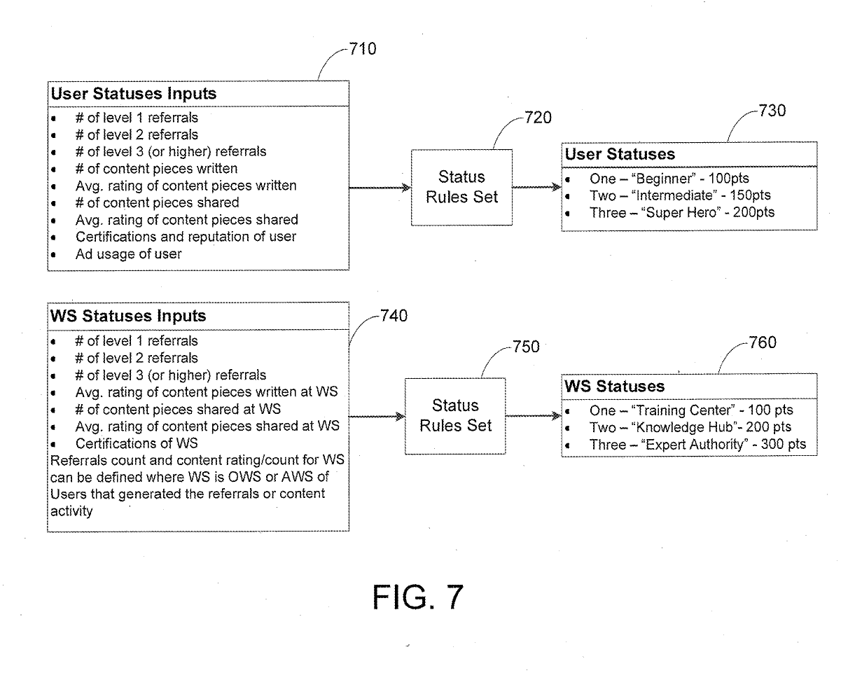

Statuses in reward distribution can also be provided as indicated at 610. For example, users reaching a first status level may earn 5% rewards of the fee and users reaching a second, higher status level may earn a higher 6%. In another example, a WS may also earn higher rewards when the website's users reach a certain status. For example, if fifty users of the WS reach the first status level, they may earn 5% of the commission fee, whereas if a hundred users of the WS reach the first status level, the WS would earn 6% of the rewards. As described in more detail below in reference to FIG. 7, user status inputs 710 and website status inputs 740 may be used to calculate rewards as shown in 610. Many such inputs and rules are envisioned in the reward rules set but do not limit the reward rules set. The reward rules sets also allow the statuses and points for Users 730 and Websites 760 to generate additional rewards for the respective users and websites.

FIG. 7 shows exemplary statuses in the RMS. The RMS has status rules sets 720 that enable users and websites to gain statuses in the RMS as shown at 730. For example, as shown at 730, Users may gain statuses such as “Beginner”, “Intermediate” and others. By taking the inputs 710 and applying rules contained in the status rules set 720, a user can gain statuses. For example, User 1 may gain status “Intermediate” because they have ten first status level referrals and thirty second status level referrals. The rules within the status rules set determine how many referrals and other inputs are needed to gain one status or another. Points may be used in determining status level. For example, getting one first status level referral gets a user ten points and having ten first status level referrals gains the user a hundred points. Plus the user may get fifty points for writing two reviews rated 3.5 or higher on a five point scale and therefore the total points of a user can reach 150 which gains the user a status of “Intermediate”. Many such algorithms can be utilized in the status rules set

Websites may gain statuses as shown at 760 and points such as “Training Center” and “Expert Authority” and others similar to how users may gain statuses and points. The example website status inputs 740 may be used by the status rules set 750 to determine the actual status of the website. For example, a first website could gain a status of “Training Center” by gaining a hundred points of which twenty-five points were for the number of first and second status level referrals and seventy-five points for the number of average content shared at the website by their users.

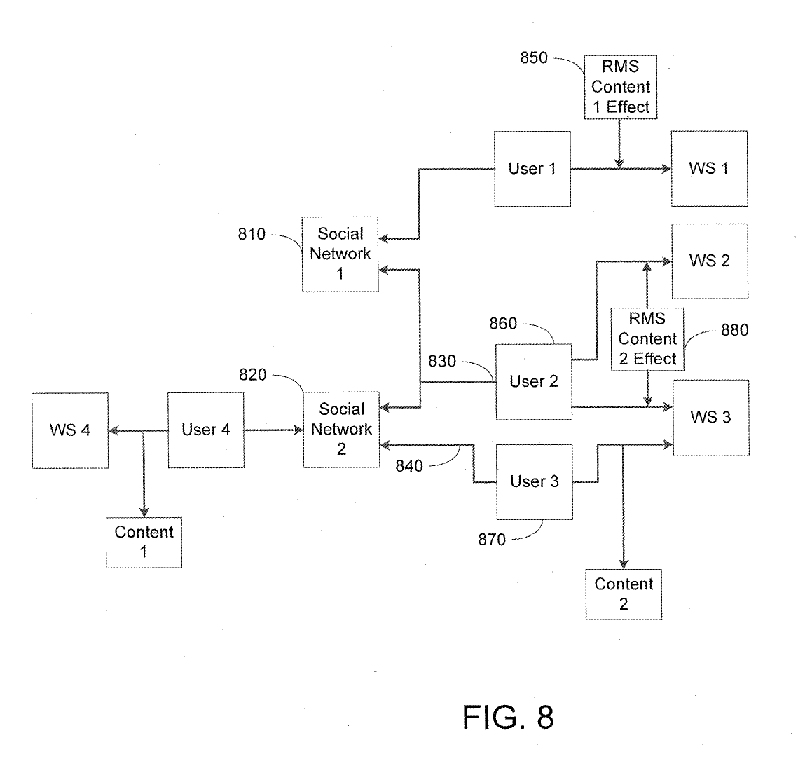

FIG. 8 is an exemplary diagram illustrating how the RMS utilizes social network data to affect a user's view of content regardless of the website from which the user is accessing the RMS. First and second social networks 810 and 820 show that the RMS can use the user login and data information services from two different social networks depending on the network with which the user is associated. The RMS may store multiple records for social network data per user such that User 1 and User 2 may be part of the same social network and therefore the RMS can ascertain that they are friends in that network. Since the RMS uses multiple social networks, User 2 may additionally be part of a different social network as shown at 830. In the exemplary illustration, User 3 uses the same Social Network 2 (integrated with the RMS) as User 2 and therefore if User 2 and User 3 are friends in Social Network 2, the RMS can identify this fact. Accordingly, in one example, if Users 1, 2, 3 and 4 are all related in some way, this fact can be recognized by the RMS even if Users 1 and 2 are in a different social network than Users 3 and 4. The RMS recognizes that: Users 1 and 2 are direct (connection level 1) friends, Users 2 and 3 are direct friends, Users 3 and 4 are direct friends, and Users 4 and 2 are indirect friends (connection level 2) at one connection apart since Users 2 and 3 are friends. In a similar way, the RMS recognizes that Users 4 and 1 are also indirect friends at connection level 3 in the illustrated example. There are many possibilities to relate users (at many connections levels) in the RMS even though users use a different social network or a different website to access the RMS. FIG. 8 shows examples of some of the connections possible, but is not intended to be limiting.

When users access the RMS via websites, content may be prioritized or filtered due to the relationship of the author of the content or the relationship to a user who has interacted with the content. For example, in FIG. 8, RMS Content 1 Effect 850 may give priority to Content 1 to show for User 1 because User 1 has a connection with User 4 who is the author of Content 1. In this case, the connection level is four between User 1 and User 4. Further, by utilizing the website relevancy profile, Content 1 may or may not be shown depending on the rating or relevancy parameters and data of Content 1 despite the relationship of Users 1 and 4. In one example, User 4 may be an expert level author writing a review or guide and Website 1 has a relevancy profile that prioritizes expert content so that Content 1 is shown to User 1. In another example, if Website 1 had a relevancy profile that filtered out expert content, then Content 1 would not show even though there is a connection between User 1 and 4.

In still another example, Users 2 and 3 in FIG. 8 (860 and 870) are friends but access the RMS via two different sites, i.e., Websites 2 and 3. If User 3 interacts with Content 2 to indicate it is of high quality and for expert users, then User 2 may see Content 2 prioritized differently when accessing Websites 2 and 3. RMS Content 2 Effect 880 may have Website 3 prioritize Content 2 for User 2 due to the relationship of User 2 to User 3 and the relevancy profile of Website 3. For example, Website 3 had a relevancy profile of expert content and that would show Content 2 higher there. Website 2 may have a relevancy profile of novice content and that would show Content 2 lower there. If Content 2 is a review, the prioritization effect may occur on the item that Content 2 is rating or on Content 2 itself.

In yet another example, by utilizing the relationship information and website relevancy profiles, the RMS may also show the differing counts of content written by user's friends depending on which website they are at. For example, User 2 may see different counts of reviews that User 2's friends have written at Website 2 and 3 due to the different relevancy profiles of the websites and other relationship information.

There are many rules possible that allow content to be prioritized or filtered by the relevancy profile of a website combined with the users relationship with other users that write the content or that have indicated (or rated) content quality.

Social information that is gathered by the RMS may be used at a website to modify the website's relevancy profile. For example, in FIG. 8, Website 1 may change its relevancy profile to novice due to the social relationship and profile data of its users including User 1 and the social relationship of User 1 to Users 2, 3 and 4. The RMS may determine that Users 2 and 4 are novice users and therefore change its relevancy profile. The RMS may also use aggregate data of Website 1 users to alter the relevancy profile of Website 1. In addition, the RMS may utilize the relevancy profiles of Websites 4, 2 and 3 to alter the relevancy profile of Website 1 based in part on the social relationships amongst the users of Website 1. There are many possibilities of configuration possible on the website relevancy profile.

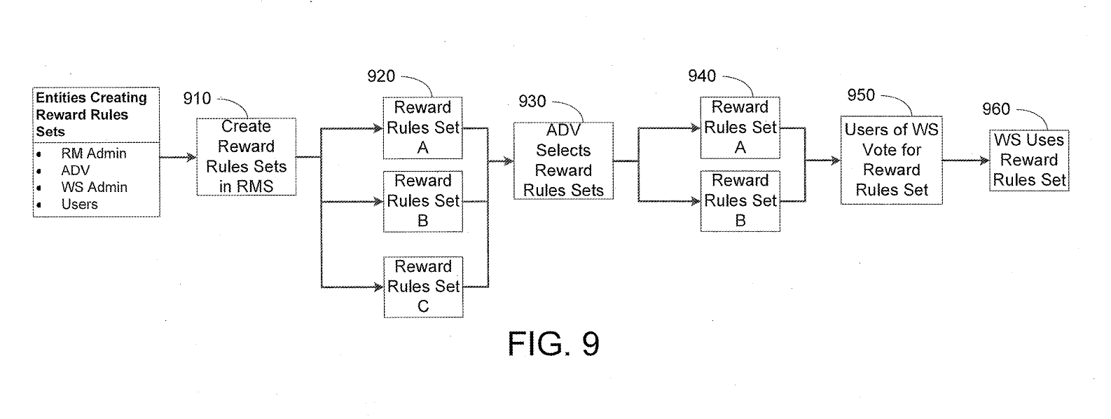

With reference to FIG. 9, exemplary collaborative reward rules processing will now be described. Advertisers, RMS administrators, Websites and other Users can create reward rules sets and one or more Advertisers can select those sets to apply to one or more of their ads or advertiser programs. Websites can select the reward rules sets that are available for the advertiser program. The advertiser programs available on a website may also be subject to the partner matching functionality of the RMS. Reward Rules Sets contain rules and instructions of how to distribute rewards to the various entities. Rules can include varying the commission fee amounts that are paid to the entities described in FIG. 6 during a reward payout. For example, one reward rules set may state that users attaining first status level can earn 5% more on their current reward level for an ad commission fee. Users of a website can also vote for which reward rules sets they would like to use on that website. The website would select the reward rules that the majority of their users voted for. There are many variations of the user voting and reward rules selection by a website that are possible.

This functionality can be accomplished by presenting the user a screen or window within the RMS to create reward algorithm rules. As shown at 910 in FIG. 9, various users create one or more reward rules sets. At 930, advertisers select which reward rules sets are applicable to their ads and advertiser programs. Advertisers may choose different reward rules sets for different ads or advertiser programs. Optionally, as shown at 940, advertiser and website partner matching may determine which advertiser programs are available at a website. The website may also choose which ads and advertiser programs are available for their websites. When an advertiser program is available for a website, users of the website may vote for which reward rules set to use when participating in the ad or advertiser program as indicated at 950. If there are more than one advertiser program or ad available at a website, users may choose to participate in one or more advertiser programs and all advertiser programs could be active. Different reward rules sets can apply to the different advertiser programs or ads. Thereby, groups of users at one website may be participating in different reward rules sets.

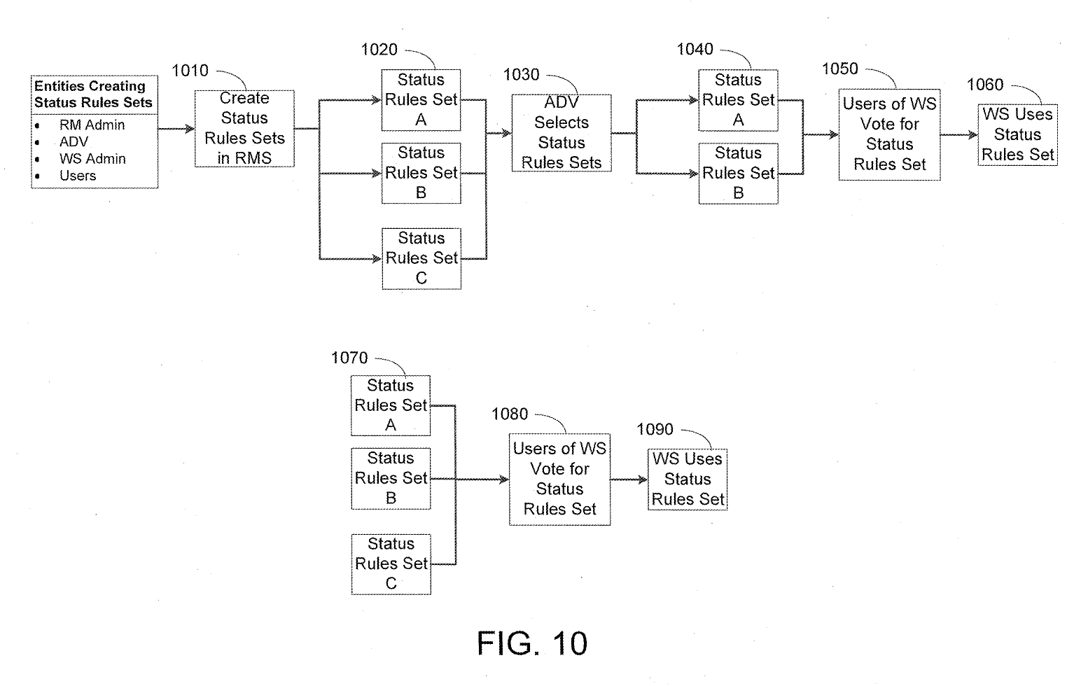

With further reference to FIG. 10, exemplary collaborative status rules sets processing will now be described. In the same way as reward rules sets, the various entities such as Advertisers, RMS administrators, Websites and other users can also generate and utilize status rules sets for websites in the RMS. This can allow websites to have different rules to attain status levels for groups of their users. Even the status names can be configurable according to the status rules sets opted by the website for various groups of users. By way of example, FIG. 10 illustrates how websites can provide status rules sets for groups of their users. Status rules sets are created as indicated at 1010 and therefore available. Advertisers select a subset of those status rules sets as indicated at 1040. Websites make the status rules sets available for their users. Users participate in ads and advertiser programs and vote on which status rules sets to use as indicated at 1050. Groups of users utilize the status rules sets on the website as indicated at 1060. A variation of this is also shown in FIG. 10 where the advertiser programs are not required for groups of users to utilize status rules sets at a website. Status rules sets are available as indicated at 1070 and users of a website vote on which status rules sets to utilize as indicated at 1080. According to the results of the voting or scoring process, groups of users at the website utilize the status rules sets as indicated at 1090.

Users can participate in various advertiser programs in various websites to gain statuses and rewards. The RMS can calculate the statuses and rewards for users that participate in multiple advertiser programs and websites to give users additional statuses and rewards. The total statuses and rewards for users can also be calculated by creating status and reward rules sets that contain rules for multiple websites and advertisers and rules for calculating the combination of multiple status and reward rules sets. The statuses and rewards gained by a user across multiple websites and advertiser programs can be displayed for that user at one or more websites.

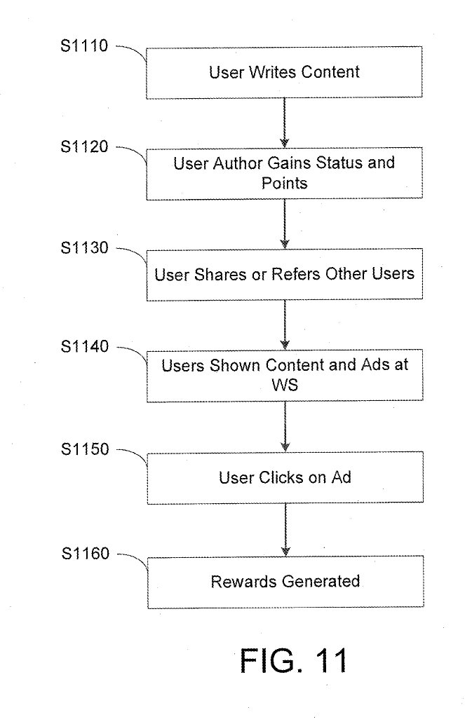

Users and websites may gain rewards and statuses based on quality of content. An example of this is shown in FIG. 11 wherein an exemplary method for generating rewards based on quality of content is illustrated. More particularly, a user can author content (S1110) and this content can then be rated by other users. Some examples of content are reviews, guides, and alerts. Other users rate the content. Top-rated content is prioritized in the RMS based on content ratings, website relevancy profile and/or partner matching rules. Content ratings may also be based on the website at which the content was rated according to the website's reputation and other factors. Due to the content ratings which may occur at multiple websites, an author user may gain additional status, points and rewards as determined by reward and status rules sets (S1120). Users that share content may also benefit in rewards, statuses and points due to the rating of the content at one or more websites according to the reward and status rules sets (S1130). Generally users are shown ads at one or more websites (S1140). When a user clicks an ad (S1150) (i.e., an Ad Action), then many entities may benefit and have reward generated (S1160) according to the applicable reward rules set and in part by the content rating of the associated content as described in the reward rules set. For example, an additional reward of 5% can be added based on the content rating of the content that is responsible for enrolling the Ad Action user because the said content has a rating of 3 or higher on a five point scale.

As will be appreciated by those skilled in the art, login compatibility can be provided between the RMS and a social network system. For example, users may enroll in the RMS and utilize the sign-in and user profile services of a third-party website or system (e.g., social network 30 of FIG. 1). The third-party website can be, for example, a social network that provides sign-in for users, an API for external systems to sign-in users and provide user information to the external systems which utilize the services. User information includes, for example, user names, preferences and relationships to other users, etc.

Users may also select other users, products, advertisers and websites as preferred objects. When a user selects a preferred object, the RMS will provide status update information about that preferred object to the user via the RMS interface or indirectly via the social network system. In one example status update information can be a message about what the preferred object is currently doing. A website may indicate they are releasing new features on their website and this message would be displayed to users in a status update information section in the RMS or on the social network message stream of the users that have selected the website as a preferred object. The integration of the RMS with the social network enables the RMS to selectively post messages to the social network message stream of users. The RMS may also gather status update information for preferred objects such as users, websites and advertisers directly from the appropriate social network system of the preferred object.

The status update information may also include advertisements. When users access the status update information advertisement, the RMS can generate the commission, status and rewards as shown earlier in FIG. 2.

Additional commissions, statuses and rewards can be generated in the RMS for a user and the users referral chain entities based on which preferred objects and the number of preferred objects that the user has selected in the RMS. The previously described status rules sets and the reward rules sets can contain the rules for such calculations in the RMS.

When a product is selected in the RMS as a preferred object, the status update information for that product can be generated by other users or an RMS administrator.

Status update information can be review-enabled to allow other users in the RMS to rate the status update information. The RMS contains rules that dictate which status update information to disseminate to users according to the ratings of the status update information and the website relevancy profile of the AWS or OWS of the users that selected the product as a preferred object.

As will also be appreciated by those skilled in the art, collaborative highlighter features can be enabled. For example, users may highlight a part of a review or content. Other users can then see the count of how many others highlighted the same (or highlighted close to that) part of that review. The RMS enables the website relevancy profile to filter or limit the count of highlighters shown to users of the website. Accordingly, if a user is identified as an advanced user and highlights content within a review or article and the website relevancy profile has set their highlighter level to advanced, then that highlight is counted when shown at the website. However, if the website relevancy profile has set the user's highlighter level to novice, then the aforementioned highlight is not counted when shown at the website. Another example is that if five novice users and 200 advanced users highlighted a particular section of content, users of a website that has relevancy profile of advanced would see the highlight and users of a website that has relevancy profile of novice would not see the highlight.

The website relevancy profile settings for targeting content can also be used to identify the type of user that is highlighting the content. For example a website whose relevancy profile contained novice content targeting would cause all highlights from users at that website to count toward novice highlights.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system for managing referrals and/or coordinating review-enabled content, the system comprising:
at least one advertiser having at least one ad;
at least one website having website content hosted on at least one machine server;
a social network hosted on said at least one machine server; and
a review management system (RMS) hosted on said at least one server, said RMS having a database including a plurality of products, one or more reviews associated with each of said plurality of products, and/or one or more review/feedback factors associated with each of said one or more reviews, said database further including a coupling association between said at least one ad of said at least one advertiser and said at least one website, said RMS configured to generate a review management web document from said database, said RMS operatively connected to said social network and to said at least one website over an electronic network.

2. The system of claim 1 further including:
a plurality of users including at least a first set of members that are member users of said social network and at least a second set of members that are member users of said RMS.

3. The system of claim 2 wherein at least some users are members users of both said social network and said RMS.

4. The system of claim 1 wherein said at least one server includes a first server, a second server and a third server, said at least one website hosted on said first server, said social network hosted on said second server and said RMS hosted on said third server.

5. The system of claim 1 further including:
a website web document accessed by said plurality of users, said access web document configured to display said website content from said at least one website and said review management web document from said RMS.

6. A method for calculating status and points in the system of claim 2, comprising:
creating an advertiser program;
signing up at least one user of said plurality of users with said advertiser program;
sharing or referring other users of said plurality of users;
showing ads to said other users and clicking on one of said ads;
calculating a commission; and
calculating status and points.

7. A method for website and partnership matching in the system of claim 2, comprising:
enrolling said at least one website in said RMS;
enrolling said at least one advertiser in said RMS;
showing review content of said RMS to said plurality of users at said at least one website; and
showing said at least one ad of said at least one advertiser to said plurality of users at said at least one website.

8. The system of claim 2 wherein said RMS is configured to generate reward results to said plurality of users based on status-related inputs, ad action-related inputs and/or a reward rules set.

9. The system of claim 2 wherein said RMS is configured to generate user statutes based on user statuses inputs and a status rules set.

10. The system of claim 2 wherein said RMS is configured to generate website statuses based on website statuses inputs and a status rules set.

11. The system of claim 2 wherein said RMS is configured to delivery content based on social network data from said social network and website relevancy profiles.

12. The system of claim 2 wherein said RMS is configured to provide a reward rules set for said at least one website based on collaboration from said plurality of users.

13. The system of claim 2 wherein said RMS is configured to provide a status rules set for said at least one website based on collaboration from said plurality of users.

14. A method for calculating status and points in the system of claim 2, comprising:
receiving user written content from a user author of said plurality of users;
assigning status and points to said user author;
show said website content and said at least one ad at said at least one website to other users shared or referred by user author;
receive indication of ad selection; and
generate rewards based on ad selection.
